(19) United States
(12) Patent Application Publication
(10) Pub. No.: US 2022/0031558 A1
(43) Pub. Date: Feb. 3, 2022

(54) Mountable Massage Device

(71) Applicant: Open Chain Corporation, Westlake Village, CA (US)

(72) Inventors: Chris DiVecchio, Hawthorne, CA (US); David Garden, Westlake Village, CA (US); Don Brown, Williamsport, CA (US)

(21) Appl. No.: 16/945,511

(22) Filed: Jul. 31, 2020

(51) Int. Cl. A61H 15/00

(52) U.S. Cl. CPC A61H 15/00; A61H 2205/081; A61H 2015/0021

(57) ABSTRACT

A mountable massage device is configured to have an adjustable length and be secured in a frame, such as a door frame, or other appropriate structure. In one disclosed embodiment, the device comprises a threaded rod, a center tube, first and second extension tubes, and first and second braces configured to support the device when secured in a frame. Handles are coupled to the center tube and allow a user to rotate the tube, thereby extending or retracting the extension tubes. This allows a user to match the length of the device to the width of a door frame. Massage pads are coupled to the center tube and may be used to massage a user's muscles.

### BACKGROUND

Massage pads come in many forms. One example is a foam cylinder that is placed on the ground so that a user may roll over the foam cylinder to massage a muscle. For such products, a user identifies a sore or tight area of the user's muscle, then positions their body so that the sore area is positioned atop the foam cylinder. The user then rolls the muscle back and forth over the foam cylinder as it rolls on the floor, and may hold the muscle on the foam cylinder at a point of discomfort to focus pressure on the muscle. By placing more bodyweight on the targeted muscle, a user can apply additional pressure to the massaged area. Such motions are used to massage large muscles, such as the quadricep, calf, hamstring, gluteus maximus, and latissimi dorsi (lat) muscles.

### SUMMARY

A mountable massage device is configured to have an adjustable length and be secured in a frame, such as a door frame, or other appropriate structure. In one disclosed embodiment, the device comprises a threaded rod, a center tube, first and second extension tubes, and first and second braces configured to support the device when secured in a frame. Handles are coupled to the center tube and allow a user to rotate the tube, thereby extending or retracting the extension tubes. This allows a user to match the length of the device to the width of a door frame. Massage pads are coupled to the center tube and may be used to massage a user's muscles.

### BRIEF DESCRIPTION OF THE DRAWINGS

The detailed description makes reference to the accompanying figures wherein:

FIG. 1 illustrates an embodiment of a mountable massage device in accordance with the principles disclosed herein.

FIG. 2 illustrates mountable massage device shown in FIG. 1, with the first and second extension tubes in an extended position.

FIG. 3 illustrates components of an embodiment of a mountable massage device.

FIG. 4 illustrates an exploded view of components of an embodiment of a mountable massage device.

FIG. 5 illustrates an embodiment of a mountable massage device mounted in a door frame.

The figures are only intended to facilitate the description of the principles disclosed herein. The figures do not illustrate every aspect of the principles disclosed herein and do not limit the scope of the principles disclosed herein. Other objects, features, and characteristics will become more apparent upon consideration of the following detailed description.

### DETAILED DESCRIPTION

A detailed illustration is disclosed herein. However, techniques, methods, processes, systems and operating structures in accordance with the principles disclosed herein may be embodied in a wide variety of forms and modes, some of which may be quite different from those disclosed herein. Consequently, the specific structural and functional details disclosed herein are merely representative.

None of the terms used herein, including “brace,” “collar,” “handle,” “tube,” and “rod” are meant to limit the application of the principles disclosed herein. The terms “first,” “second,” and the like may refer to different or identical objects. The foregoing terms are used to illustrate the principles disclosed herein and are not intended to be limiting. Other explicit and implicit definitions may also be included below.

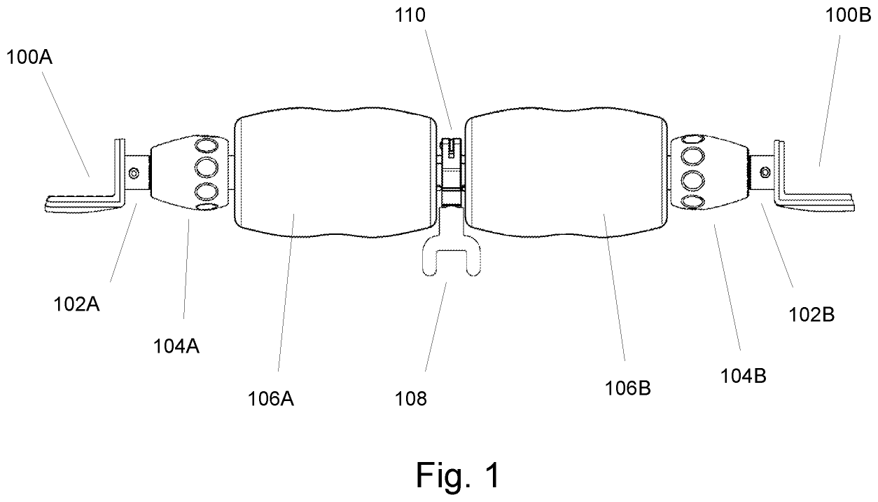

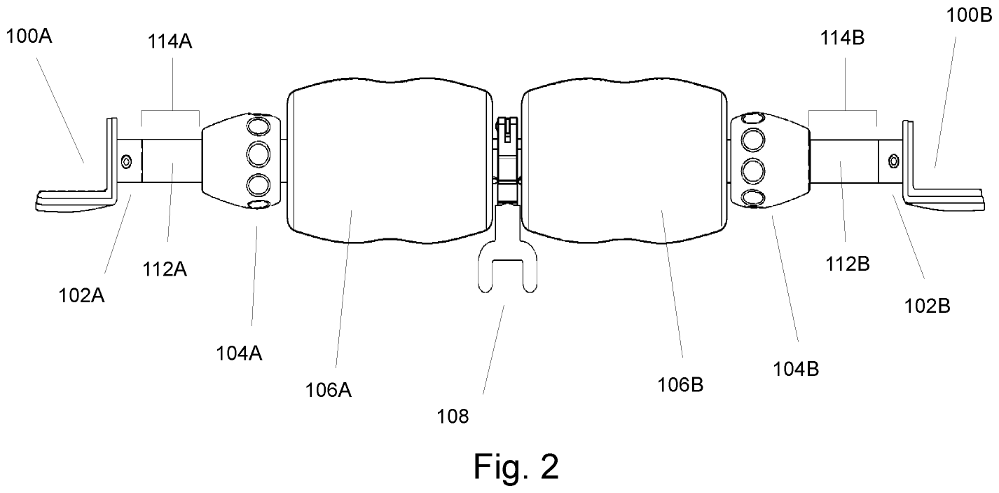

With reference to FIG. 1, shown is a mountable massage device capable of being secured in a frame, such as a door frame, or other appropriate structure. At the ends are first brace 100A and second brace 100B. In some embodiments, soft material such as one or more pads are mounted on the surface of such braces. Soft material is intended to avoid leaving marks or otherwise damaging a frame when the mountable massage device is secured in the frame. Coupled to the first brace 100A is first brace collar 102A which is coupled to first extension tube 112A (shown in FIG. 2). Coupled to the second brace 100B is second brace collar 102B which is coupled to second extension tube 112B (shown in FIG. 2). First handle 104A and second handle 104B are mounted on a center tube (not shown) and configured to rotate with the center tube to adjust the length of the mountable massage device. First pad 106A and second pad 106B are also supported on the center tube (not shown) and are configured to rotate independently of each other and independently of first brace 100A and second brace 100B. Between first pad 106A and second pad 106B are massage accessory 108 and cam lock 110. When the mountable massage device is fixed in a frame, by which first brace 100A and second brace 100B are secured to the frame, cam lock 110 may be released to allow the cam lock 110 to rotate freely around. Cam lock 110 contains a mount to receive a massage accessory, such as massage accessory 108 shown in FIGS. 1 and 2. Once the user places the massage accessory 108 in a desired position, cam lock 110 can be locked, thereby holding massage accessory 108 in place with respect to the rest of the mountable massage device.

With reference to FIG. 2, shown is the mountable massage device with first extension tube 112A and second extension tube 112B in extended positions. By rotating first handle 104A and second handle 104B, a user can extend first extension tube 112A and second extension tube 112B, as shown by the extended length 114A and extended length 114B, respectively. In order to mount the device, the user extends the first extension tube 112A and second extension tube 112B sufficiently far for first brace 100A and second brace 100B to mate with a frame, such as the sides of a door frame, or other appropriate structure.

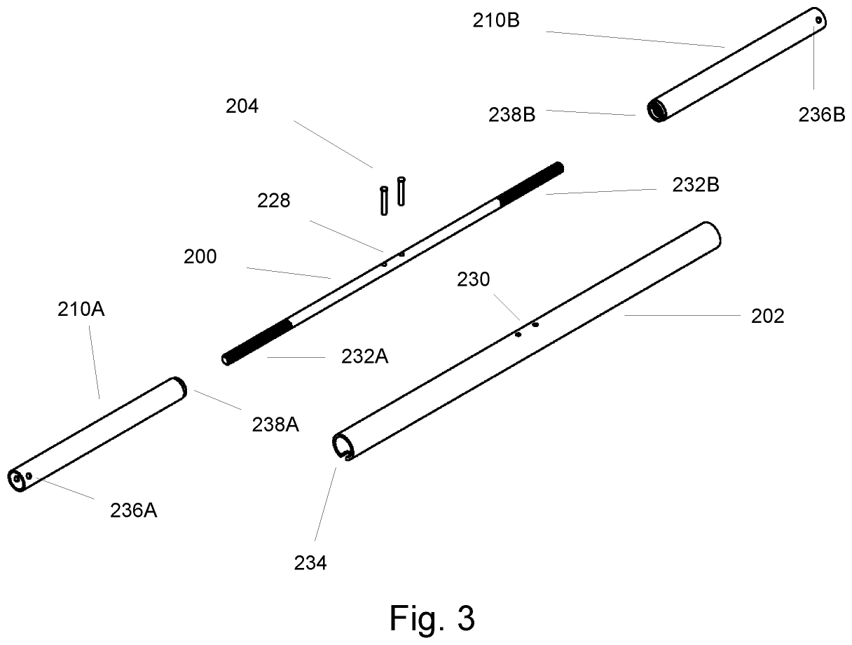

FIG. 3 illustrates the rod and tubes that form the center of a mountable massage device in accordance with the principles disclosed herein. Shown are threaded rod 200, center tube 202, first extension tube 210A, and second extension tube 210B. Threaded rod 200 has threaded rod pin holes 228, and center tube 202 has center tube pin holes 230. In the embodiment shown, two holes are disposed in threaded rod 200 and in center tube 202, but in alternative embodiments, one or many pin holes may be used. Also shown is center tube notch 234, which is disposed at the end of center tube 202. A similar notch (not shown) is disposed at the opposite end of center tube 202. First extension tube 210A comprises a first extension tube pin hole 236A and a first threaded interior 238A on the opposite end. Second extension tube 210B comprises a second extension tube pin hole 236B and a second threaded interior 238B on the opposite end. Preferably, first extension tube 210A comprises a threaded interior (first threaded interior 238A) that extends through the entire length of the first extension tube, and second extension tube 210B comprises a threaded interior (second threaded interior 238B) that extends through the entire length of the second extension tube. In some embodiments, first threaded interior 238A may extend only partially through the length of first extension tube 210A, and/or second threaded interior 238B may extend only partially through the length of second extension tube 210B.

When assembled, threaded rod 200 is placed through the middle of center tube 202 so that threaded rod pin holes 228 align with center tube pin holes 230. Center pins 204 are then placed through threaded rod pin holes 228 align with center tube pin holes 230 and secured. First extension tube 210A is screwed onto threaded rod 200 by engaging first threaded interior 238A with first threads 232A. Second extension tube 210B is screwed onto threaded rod 200 by engaging second threaded interior 238B with second threads 232B. In this position, first extension tube 210A and second extension tube 210B are both engaged with threaded rod 200 and extending out from the interior of center tube 202.

In some embodiments, threaded rod 200 is threaded across its entire length instead of at the ends as shown in FIG. 2. Threading across the entire length may assist in manufacturing and provide a larger range of motion for first extension tube 210A and second extension tube 120B when the mountable massage device is assembled. In such embodiments, the orientation of threading on one side of threaded rod 200 should be opposite of the orientation of threading on the other side.

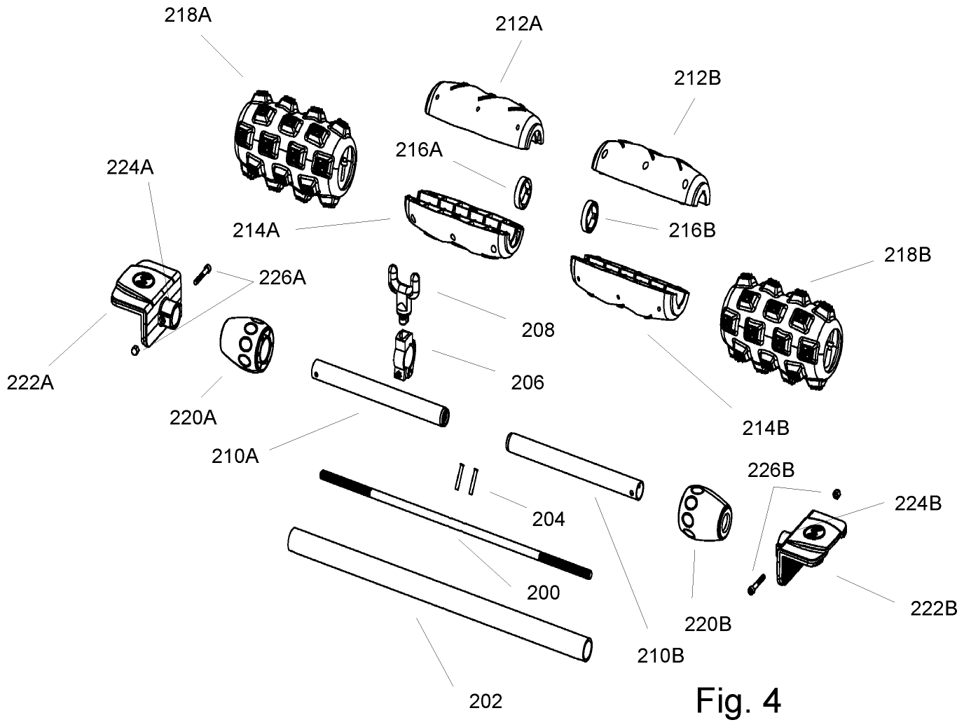

FIG. 4 illustrates an exploded view of a mountable massage device in accordance with the principles disclosed herein. Shown are threaded rod 200, center tube 202, center pins 204, first extension tube 210A, and second extension tube 210B, which are to be assembled as described above. In assembly, cam lock 206 is positioned around the center of center tube 202, and massage accessory 208 is coupled to cam lock 206. First connector 216A is positioned on center tube 202, and first top support 212A and first bottom support 214A are coupled to center tube 202 and first connector 216A. Second connector 216B is positioned on center tube 202, and second top support 212B and second bottom support 214B are coupled to center tube 202 and second connector 216B. First massage pad 218A is positioned around first top support 212A and first bottom support 214A. Second massage pad 218B is positioned around second top support 212B and second bottom support 214B. First handle 220A is positioned so that first extension tube 210A passes through it, and first handle 220A is fixed to one end of center tube 202. Second handle 220B is positioned so that second extension tube 210B passes through it, and second handle 220B is fixed to the opposite end of center tube 202. First handle 220A and second handle 220B are securely coupled to center tube 202 by, for example, screws and/or adhesive. First brace 222A comprises first brace collar 224A, which is positioned on the free end of first extension tube 210A and secured to first extension tube 210A by first brace nut and bolt 226A. Second brace 222B comprises second brace collar 224B, which is positioned on the free end of second extension tube 210B and secured to second extension tube 210B by second brace nut and bolt 226B.

Once the mountable massage device has been assembled, the length may be extended by rotating the center tube 202 (which is affixed to threaded rod 200) with respect to first extension tube 210A and/or second extension tube 210B. When first threads 232A of threaded rod 200 are rotated relative to first threaded interior 238A of first extension tube 210A, threaded rod 200 and first extension tube 210A either extend or contract, depending on the direction of rotation. Likewise, when second threads 232B of threaded rod 200 are rotated relative to second threaded interior 238B of second extension tube 210B, threaded rod 200 and second extension tube 210B either extend or contract, depending on the direction of rotation. Preferably, first threads 232A and first threaded interior 238A are oriented in a complementary direction with second threads 232B and second threaded interior 238B. That way, when first extension tube 210A and second extension tube 210B are rotationally fixed, and threaded rod 200 is rotated, then first extension tube 210A and second extension tube 210B simultaneously extend outward or simultaneously contract inward, depending on the direction that threaded rod 200 is rotated. This configuration enables the center of the mountable massage device to remain centered while the first brace 222A and second brace 222B are extended outward.

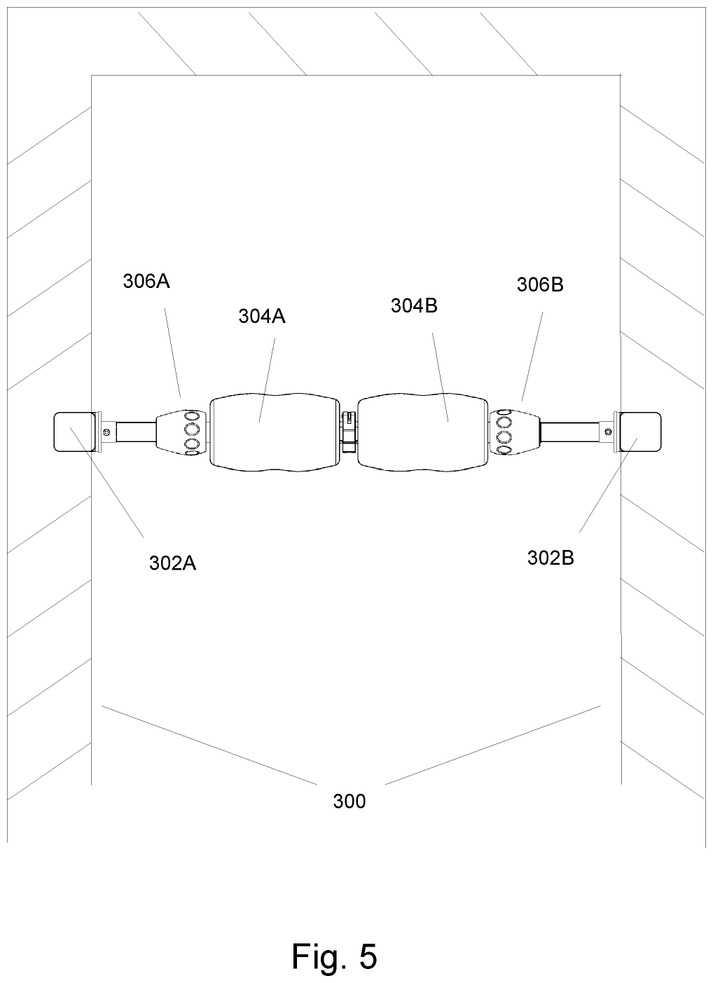

With respect to FIG. 5, a user places a mountable massage device in a doorway so that the first brace 302A is touching (or nearly touching) one side of the doorframe 300 and second brace 302B is touching (or nearly touching) the other side of the doorframe 300. The user then grasps left handle 306A and right handle 306B and rotates them, thereby extending out first brace 302A and second brace 302B against doorframe 300. During this process, doorframe 300 prevents first brace 302A and second brace 302B from rotating since the plates on each of first brace 302A and second brace 302B are pressing against the sides of door frame 300. The user rotates left handle 306A and right handle 306B until the mountable massage device is securely held in place within door frame 300. The user may then roll or press a muscle against first massage pad 304A and/or second massage pad 304B. Depending on how securely it is held in door frame 300, the mountable massage device may be able to support the full bodyweight of a user.

In some embodiments, an additional locking collar is disposed on an extension tube. The locking collar engages with the handle and locks it in place so that the center tube can no longer rotate with respect to the extension tube. The locking collar may have a clasp or handle that allows a user to secure the collar in position or release the collar and enable the handle to freely rotate again.

In some embodiments, a mountable massage device comprises only one massage pad. The massage pad may be configured to be an appropriate length, and may extend across the length of the center tube or may be longer or shorter as desired. In some embodiments, plastic bushings are disposed on each side of a roller formed by a top support and a bottom support. In some embodiments, one or more spacers are disposed between a pair of rollers. The spacers are preferably comprised of rubber, but other appropriate materials may be selected. The use of plastic bushings and/or a spacer(s) may improve the ability of the massage pad(s) to spin smoothly and quietly.

In some embodiments, alternative massage accessories may be coupled to a cam lock (such as cam lock 110 shown in FIG. 1). For example, a massage accessory may comprise a massage ball that enables a user to apply pressure to a more precise point than a larger massage pad would. Another example is a massage accessory that comprises two prongs that can be used to massage the sides of a person's spine. To use such an accessory, the person secures the mountable massage device below shoulder height, and then can press on the accessory with their back and move up and down to massage the muscle tissue on each side of the spine. Other accessories may be coupled to a mountable massage device without departing from the principles disclosed herein.

In some embodiments, a mountable massage device is configured with one or zero braces. Instead, an attachment is secured to an extension tube whereby the attachment is configured to be secured to a wall or rack or other appropriate structure. By sufficiently securing one end, the mountable massage device may operate in a cantilever position. An exemplary attachment comprises a collar to lock to an extension tube and one or more prongs which can be placed into holes in a rack or frame such as those commonly found in gyms or weight rooms. The prong(s) is/are inserted into the rack or frame, thereby securing the mountable massage device in place.

In some embodiments, a mountable massage device is provided with a frame. For example, a mountable massage device may be provided with a frame that can stand independently and support the mountable massage device at a desired height for a user to massage their muscles. The frame is preferably height-adjustable so that the user may raise or lower the massage pads to a desired height.

In some embodiments, a mountable massage device comprises one or more massage pads that are freely rotatable when the mountable massage device is secured in place. In some embodiments, one or more massage pads may be held in place and prevented from rotating while the user massages a muscle. The massage pad(s) may be secured, for example, by a collar or handle or switch or screw.

In some embodiments, a massage pad may be changed by a user and replaced with an alternate massage pad. Such embodiments allow a user to switch the type of massage pad according to the user's desire. Interchangeable massage pads may vary in their size, shape, texture, firmness, surface smoothness, material composition, or other qualities.

The detailed description is not intended to be limiting or represent an exhaustive enumeration of the principles disclosed herein. It will be apparent to those of skill in the art that numerous changes may be made in such details without departing from the spirit of the principles disclosed herein.

1. A mountable massage device, comprising:
a threaded rod;
a center tube coupled to the threaded rod;
a first extension tube rotatably coupled to the threaded rod;
a second extension tube rotatably coupled to the threaded rod;
a first handle coupled to the center tube;
a second handle coupled to the center tube;
a first brace coupled to the first extension tube; and
a second brace coupled to the second extension tube.

2. The mountable massage device of claim 1, comprising at least one massage pad coupled to the center tube.

3. The mountable massage device of claim 2, wherein the at least one massage pad is rotatably coupled to the center tube.

4. The mountable massage device of claim 1, comprising at least one massage accessory coupled to the center tube.

5. The mountable massage device of claim 1, comprising:
a first massage pad coupled to the center tube; and
a second massage pad coupled to the center tube.

6. The mountable massage device of claim 5, wherein the first massage pad and the second massage pad are rotatably coupled to the center tube.

7. A mountable massage device, comprising:
a threaded rod;
a center tube coupled to the threaded rod;
a first extension tube rotatably coupled to the threaded rod;
a second extension tube rotatably coupled to the threaded rod;
a first handle coupled to the center tube;
a second handle coupled to the center tube; and
an attachment coupled to the first extension tube, the attachment comprising at least one prong.

8. The mountable massage device of claim 7, comprising at least one massage pad coupled to the center tube.

9. The mountable massage device of claim 8, wherein the at least one massage pad is rotatably coupled to the center tube.

10. The mountable massage device of claim 7, comprising at least one massage accessory coupled to the center tube.

11. The mountable massage device of claim 7, comprising:
a first massage pad coupled to the center tube; and
a second massage pad coupled to the center tube.

12. The mountable massage device of claim 11, wherein the first massage pad and the second massage pad are rotatably coupled to the center tube.
